(19) United States
(12) Patent Application Publication
(10) Pub. No.: US 2015/0042578 A1
(43) Pub. Date: Feb. 12, 2015

(54) INFORMATION PROCESSING APPARATUS AND DISPLAY CONTROL PROGRAM

(71) Applicant: Toshiba Tec Kabushiki Kaisha, Tokyo (JP)

(72) Inventor: Koji Nagai, Mishima-shi (JP)

(21) Appl. No.: 14/333,567

(22) Filed: Jul. 17, 2014

(30) Foreign Application Priority Data
Aug. 8, 2013 (JP) 2013-164778

(51) Int. Cl. G06F 3/041

(52) U.S. Cl. CPC G06F 3/041
USPC 345/173

(57) ABSTRACT

According to one embodiment, an information processing apparatus includes a panel type display unit, a touch panel type input unit that is disposed on the display unit in a stacking manner and receives an input from a user by detecting a contact, and a control unit. The control unit creates a closed region in a display region of the display unit on the basis of a trajectory obtained by the input unit detecting a contact. The control unit determines whether or not an image disposed outside the closed region displayed on the display unit is permitted to enter the closed region due to a user's operation received by the input unit, and controls display of the image on the display unit so that display corresponding to a determination result occurs.

### CROSS-REFERENCE TO RELATED APPLICATION

This application is based upon and claims the benefit of priority from Japanese Patent Application No. 2013-164778, filed Aug. 8, 2013; the entire contents of which are incorporated herein by reference.

### FIELD

Embodiments described herein relate generally to a technique of controlling display or an operation on a touch panel.

### BACKGROUND

There is a computer in which a multi-touch panel for detecting plural touches is adopted as an input device. Besides, there is a tabletop computer in which this touch panel is further enlarged and is adopted as a table top. The tabletop computer allows a large number of people to simultaneously perform operations and hold a meeting and a presentation.

In such a tabletop computer, since a single screen is shared, there is a case where one type of display data interferes with the other data, and thus an operation or display of the other data cannot be performed favorably. As a specific example, a display image of another person overlaps a display image of a user, and thus the display image of the user cannot be viewed or editing work cannot be correctly performed.

### DESCRIPTION OF THE DRAWINGS

FIG. 1 is a diagram showing an exterior of a tabletop information processing apparatus according to an embodiment.

FIG. 2 is a diagram showing a hardware configuration example.

FIGS. 3A and 3B are diagrams showing that the tabletop information processing apparatus according to the embodiment is viewed from the top.

FIG. 4 is a diagram showing an operation example when a designated region is provided according to the embodiment.

FIG. 5 is a diagram showing an example of map data stored in a storage unit according to the embodiment.

FIGS. 6A and 6B are diagrams showing examples of permission tables according to the embodiment.

FIG. 7 is a diagram showing permission and non-permission of card intrusion into a designated region according to operation content.

FIG. 8 is a flowchart showing an operation example of designation and cancel of a region according to the embodiment.

FIG. 9 is a flowchart showing an operation example when a card is operated.

FIG. 10 is a diagram showing a division example when a division occurs in a predefined region.

FIG. 11 is a flowchart showing an operation example when a division occurs in a predefined region.

### DETAILED DESCRIPTION

Embodiments described herein have been made to solve the problems described above, and an object thereof is to provide a technique for minimizing overlapping of images if a plurality of images are displayed.

In general, according to one embodiment, an information processing apparatus includes a panel type display unit, a touch panel type input unit that is disposed on the display unit in a stacking manner and receives an input from a user by detecting a contact, and a control unit. The control unit creates a closed region in a display region of the display unit on the basis of a trajectory obtained by the input unit detecting a contact. The control unit determines whether or not an image disposed outside the closed region displayed on the display unit is permitted to enter the closed region due to a user's operation received by the input unit, and controls display of the image on the display unit so that display corresponding to a determination result occurs.

In the present embodiment, separate work regions are provided on a screen, and thus interference between mutual operations is prevented. In addition, in the present embodiment, a tabletop information processing apparatus (computer) will be described. The tabletop information processing apparatus according to the present embodiment includes a large-sized liquid crystal panel in which a display surface and an operation surface face upward on a flat top plate surface.

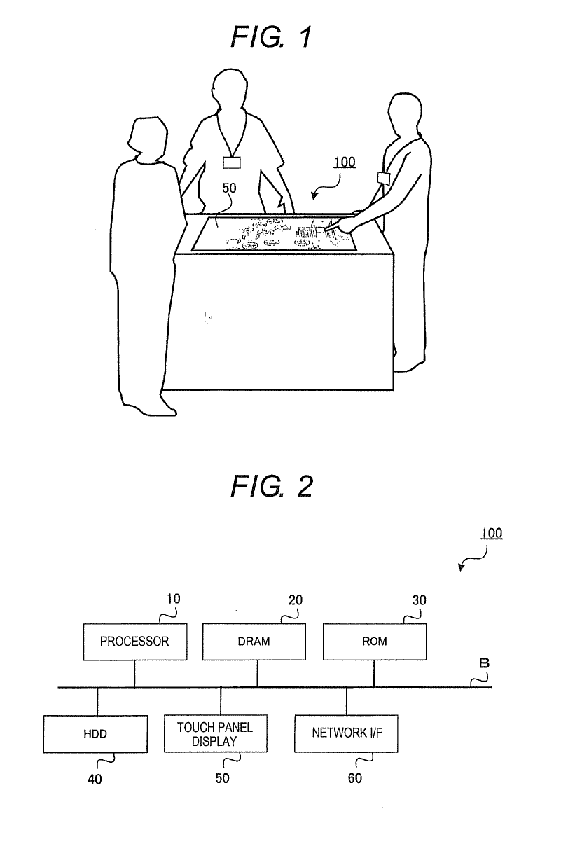

Hereinafter, with reference to the drawings, aspects of the present embodiment will be described. FIG. 1 is a diagram showing an exterior of the tabletop information processing apparatus according to the present embodiment. A tabletop information processing apparatus 100 is provided with a large-sized touch panel display 50 for an operation and display which is disposed on a top plate surface thereof.

The touch panel display 50 includes a multi-touch sensor (input unit) which simultaneously detects a plurality of contact positions and is disposed on a panel type display unit in a stacking manner, and thus an image on a screen can be controlled with a fingertip or a pen tip. The touch panel display 50 allows various content images to be displayed, and also functions as a user interface for an operation input.

FIG. 2 is a block diagram showing an example of a hardware configuration of the tabletop information processing apparatus 100. The tabletop information processing apparatus 100 includes a processor 10, a dynamic random access memory (DRAM) 20, a read only memory (ROM) 30, a hard disk drive (HDD) 40, the touch panel display 50, and a network interface (I/F) 60. The above-described constituent elements transmit and receive control signals and data to and from each other via a communication bus B.

The processor 10 is an arithmetic processor such as a central processing unit (CPU), and loads a program stored in the ROM 30, the HDD 40, or the like to the DRAM 20 so as to arithmetically execute the program, thereby performing various processes according to the program. The DRAM 20 is a volatile main storage device. The ROM 30 is a nonvolatile storage device which stores data permanently, and stores a basic input output system (BIOS) used when a system starts, and the like. The HDD 40 is a nonvolatile auxiliary storage device which can store data permanently, and stores data or a program used by a user.

The touch panel display 50 includes a capacitance type touch panel input unit (a touch panel type input unit) and a flat panel display unit (a panel type display unit). The touch panel supports multiple touches for detecting a plurality of simultaneous contacts, and thus coordinate values (an X value and a Y value) corresponding to a contact position can be obtained. In the flat panel, light emitting elements for display are provided on the entire panel surface.

The network I/F 60 is a unit which performs communication with an external apparatus, and includes a local area network (LAN) board. In addition, the network I/F 60 includes a device conforming to a near field communication standard or a connector conforming to a universal serial bus (USB) standard.

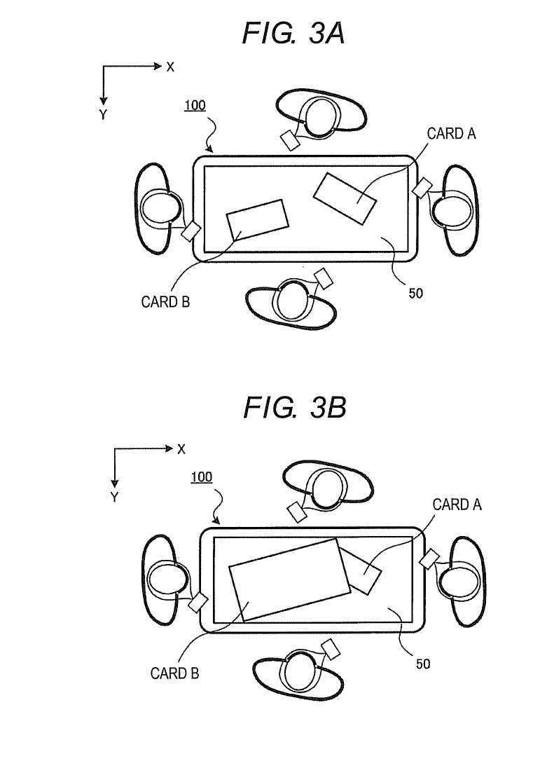

FIGS. 3A and 3B are plan views in which the tabletop information processing apparatus 100 is viewed from the top. Directions of an X axis and a Y axis illustrated in FIGS. 3A and 3B and the subsequent figures are all the same as each other. The tabletop information processing apparatus 100 allows a plurality of users to simultaneously log in. FIG. 3A illustrates an example in which four users cause cards A and B to be displayed, and discussion is taking place. In addition, in the embodiment, a display image which is displayed by each application is referred to as a card. The card A is a display image which is edited by, for example, document editing software, and the card B is a display image when any home page is displayed by browser software. A user performs a predetermined operation on a card, so as to perform enlargement and reduction display of the card, rotation, movement and new display of the card, and deletion of the display.

If one user causes the card B to be enlarged and displayed through a predetermined operation, there is a case where the card B overlaps the card A due to this operation as illustrated in FIG. 3B. In this case, if another user performs a document editing operation on the card A, the editing work is not easily performed due to the overlapping with the card B.

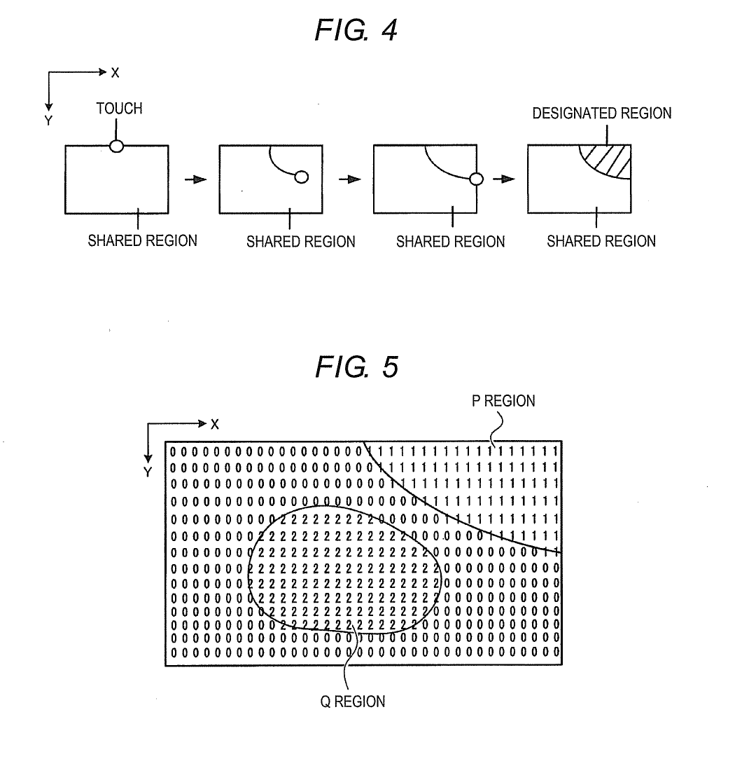

In the embodiment, a separate region is created on a screen in order to minimize such interference from other cards. This region can be created in any size and shape at any place. FIG. 4 is a diagram showing an operation example of creating the region. The creation of the region is performed by using the following procedures in a state in which a region designation mode is turned on.

1. Any location is touched.

2. A tracing operation is performed on a screen so as to create a region with any size and shape.

Hereinafter, as illustrated in FIG. 4, the created region is referred to as a designated region, and another region (outside the designated region) is referred to as a shared region.

In addition, cancelling of the designated region is performed by touching a boundary line of the created region in a state in which the region designation mode is turned on. Further, there may be a configuration of performing the cancelling by tracing (removing) the boundary line, and there may be a configuration of performing the cancelling through an operation (an operation of cutting the boundary line) of touching the inside of the designated region and moving in an outward direction from the inside of the designated region. The operation of cutting the boundary line may also be an operation of moving in an inward direction from the outside of the designated region.

Numerical value data illustrated in FIG. 5 is an example of map data corresponding to each position of a display region of the touch panel display 50. The map data is stored in the HDD 40, and is updated each time a designated region is created and canceled. In the example of FIG. 5, two designated regions (a P region and a Q region) are created, and the designated regions are respectively given individual identification numbers. In this example, the P region is given an identification number 1, and the Q region is given an identification number 2. An identification number 0 indicates a shared region, and a position where the identification number 0 is adjacent to another number becomes a boundary between regions. In the embodiment, intrusion of a card disposed in the identification number 0 into regions of the identification numbers 1 and 2 is controlled, and an outing of cards disposed in the identification numbers 1 and 2 to the shared region of the identification number 0 is also controlled.

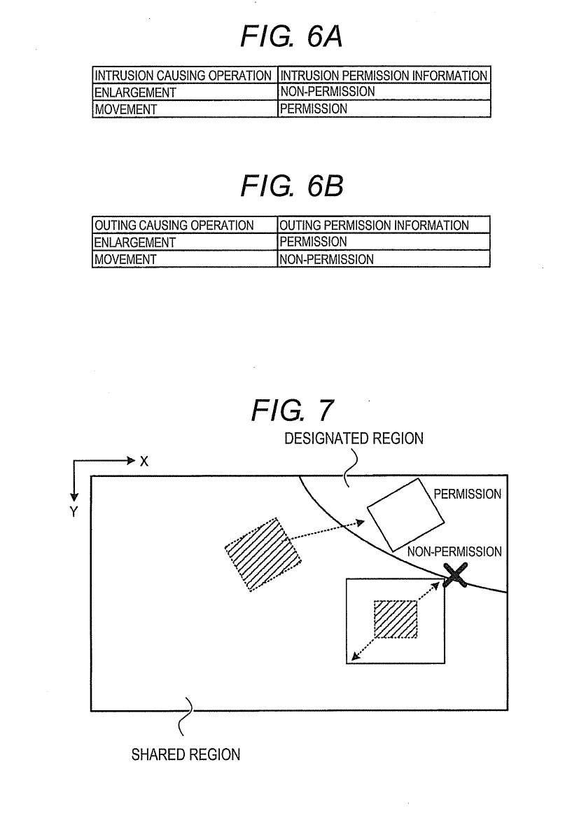

In the embodiment, for each operation content item of a user, intrusion of a card into a designated region from a shared region, and an outing of a card to the shared region from the designated region are controlled. FIG. 6A is a table illustrating whether or not intrusion into a designated region is permitted for each operation, and FIG. 6B is a table illustrating whether or not an outing to a shared region from a designated region is permitted for each operation. These data tables are stored in the HDD 40. In an example of FIG. 6A, intrusion into a designated region due to an enlargement operation is prohibited, and intrusion due to movement is permitted. FIG. 7 is a diagram illustrating this state. If a user touches a card and makes a sliding movement in a horizontal direction, the card is also moved according to the sliding movement. In this example, intrusion of a card into a designated region due to movement is permitted, and thus the card located outside can enter the designated region. Meanwhile, if the card is touched with two fingers, and the fingers are moved so that a distance gap therebetween is increased, an enlargement operation is performed. In this example, intrusion into a designated region due to the enlargement operation is prohibited, and thus the card is enlarged up to the boundary line.

In addition, in an example of FIG. 6B, an outing to a shared region from a designated region due to an enlargement operation is permitted, and an outing to the shared region from the designated region due to a movement operation is prohibited. Further, in this example, the enlargement operation and the movement operation are described, but there are a rotation operation and a new display operation as operations which may cause intrusion into a designated region and an outing from a designated region. These operations may have the intrusion permission information or outing permission information illustrated in FIGS. 6A and 6B.

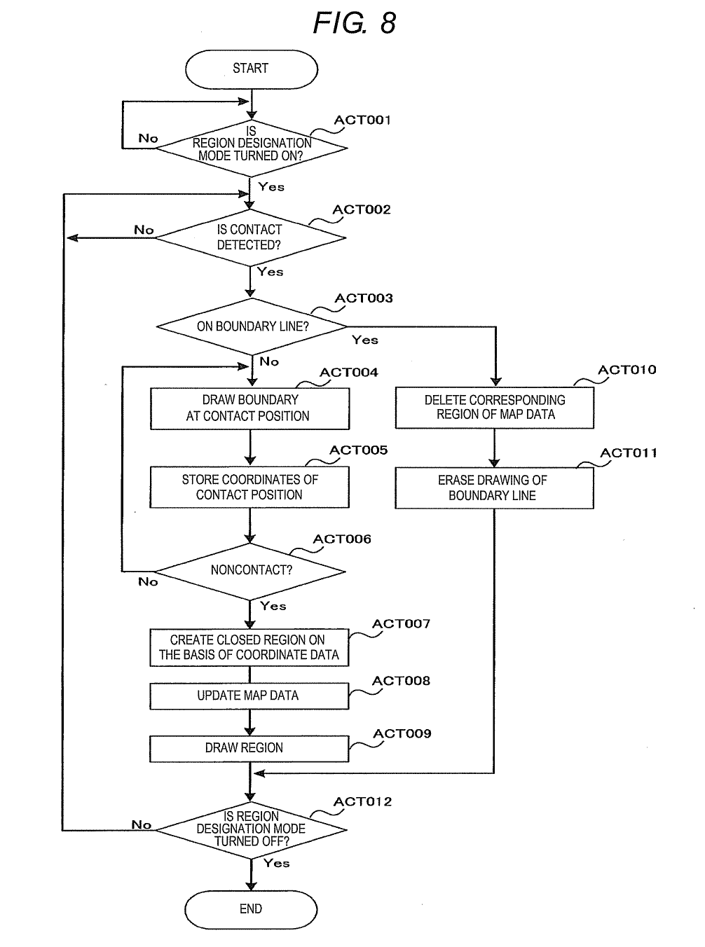

FIG. 8 is a flowchart illustrating an operation example when a designated region is created and canceled. The processor 10 develops a program stored in the HDD 40 in the DRAM 20 so as to arithmetically execute the program, thereby realizing the operation in cooperation with each hardware element.

The processor 10 determines whether or not a region designation mode is turned on (ACT 001). The mode is changed by pressing a predetermined button (not illustrated) displayed on the touch panel display 50. If the region designation mode is turned on (ACT 001, Yes), the processor 10 waits until a contact of a fingertip or a pen tip is detected by the touch panel display 50 (ACT 002, a loop of No), and if a contact is detected (ACT 002, Yes), the processor 10 determines whether or not a position of the contact is on a boundary line (ACT 003). The determination on whether or not a contact position is on a boundary line is performed by using the map data illustrated in FIG. 5, and is performed depending on whether or not a contact is detected at a boundary position (or in the vicinity thereof) between the identification number 0 and another number.

If the contact position is on the boundary line (ACT 003, Yes), the processor 10 controls the touch panel display 50 so that a corresponding designated region of the map data is deleted (ACT 010), and drawing of the boundary line is erased (ACT 011). Next, the process proceeds to a determination in ACT 012. This operation will be described with reference to the map data of FIG. 5. For example, if a boundary line of the P region is selected, the processor 10 changes data on the identification number 1 to data on the identification number 0 so as to produce a shared region in ACT 010, and deletes drawing of the boundary line in ACT 011. In addition, if each region is displayed by using each color, the processor 10 controls display of the touch panel display 50 so that the P region has a color of the shared region.

A process in ACT 003 will be described. If the contact position is not located on the boundary line (ACT 003, No), the processor 10 draws a point (for example, a black point) indicating a boundary at the contact position (ACT 004), and stores coordinate values (an X value and a Y value) of the contact position (ACT 005). The processor 10 determines whether or not the fingertip or the pen tip is separated from the touch panel display 50 and thus a noncontact is performed (ACT 006). If the noncontact is not performed (ACT 006, No), the process returns to ACT 004. ACT 004 to ACT 006 are repeatedly performed in accordance with a movement of the fingertip or the pen tip, and thus contact points are connected so as to produce a boundary line.

If the noncontact is performed (ACT 006, Yes), the processor 10 creates a closed region on the basis of the boundary coordinate values stored in ACT 005 (ACT 007). Here, the closed region is created according to the following rules. In addition, this is only an example.
If a closed region is created by a movement (trajectory) of the fingertip, the processor 10 employs the closed region.
If a closed region is not created by a movement (trajectory) of the fingertip, the processor 10 creates a closed region by connecting a start point and an end point of the trajectory.
If detection of a contact starts in the vicinity of one side of the touch panel display 50 and ends in the vicinity of a side orthogonal to the one side, the processor 10 creates a closed region so as to include orthogonal points of the two sides (refer to FIG. 4).
If the vicinities of two parallel sides are a start point and an end point of a fingertip trajectory so as to divide the touch panel display 50, a narrow region of divided regions is employed as a closed region. Alternatively, if there is a preset designated region, a region which does not include the preset region is employed as a closed region.

In ACT 007, if there is a preset designated region, the processor 10 creates a closed region so that the closed region does not overlap the preset region. For example, the processor 10 creates a closed region only at the position indicated by the identification number 0 on the map data illustrated in FIG. 5, that is, creates a closed region so that the closed region does not overlap the identification numbers 1 and 2.

In addition, in ACT 007, the processor 10 may create a closed region on the basis of a movement of the fingertip and then may shape the closed region. For example, if a trajectory of the fingertip draws a substantially square region, the processor 10 acquires a maximum value of X, a maximum value of Y, a minimum value of X, and a minimum value of Y from among the coordinate values stored in ACT 005, and creates four coordinates by combining the values. The processor 10 creates a rectangular closed region having the four coordinates as vertexes. Also in relation to a circular shape or an elliptical shape, a midpoint, a radius, a major axis, and a minor axis are calculated on the basis of the coordinate values stored in ACT 005, thereby performing shaping.

In addition, a limitation may be put so that a shared region is not lower than a prescribed value. For example, a limitation is put so that a shared region is not lower than 50% of an area of a display region of the touch panel display 50. In this case, the processor 10 counts the number of identification numbers 0 in the map table illustrated in FIG. 5, and puts a limitation so that the number is not lower than a prescribed value.

The processor 10 derives a new identification number, and updates the map data so that a value at each position of the created closed region becomes the new identification number (ACT 008). The processor 10 redraws the inside of the closed region (ACT 009). Here, for example, a color of the inside of the closed region is made different from a shared region, or a hand written line is shaped.

The operations in ACT 002 to ACT 009, and ACT 010 and ACT 011 are repeatedly performed until the region designation mode is canceled (ACT 012, a loop of No).

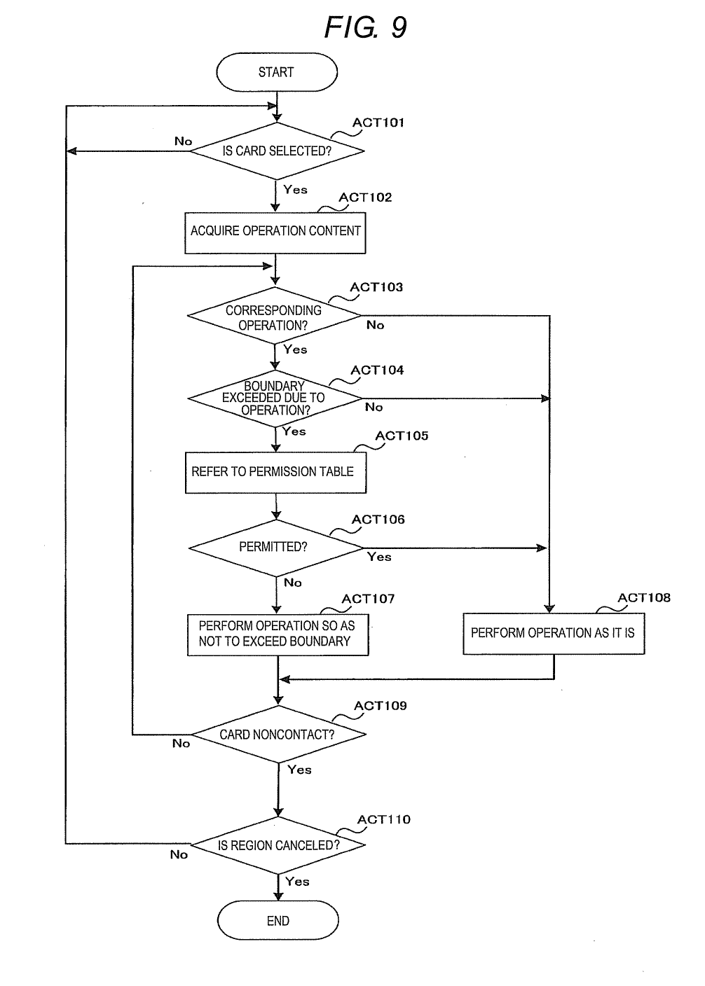

As described above, a designated region is set and canceled, and, next, with reference to a flowchart of FIG. 9, a description will be made of a control example of each card operation after the designated region is set.

The processor 10 determines whether or not there is a contact in a card display region (a card is selected) (ACT 101). The determination in ACT 101 is repeatedly performed until the card is selected (ACT 101, a loop of No). If the card is selected (ACT 101, Yes), the processor 10 acquires operation content for the card (ACT 102). For example, if two points are detected, and a gap therebetween is increased, this leads to an enlargement operation, and if the gap is reduced, this leads to a reduction operation. In addition, if respective detection points are rotated centering on an axial center, this leads to a rotation operation of the card, and if the fingertip slidably moves, this leads to a movement operation of the card. The processor 10 determines what kind of operation is performed on the basis of the number of detected points or a movement direction.

The processor 10 determines whether or not the operation content is an operation (a predefined operation) having a possibility of exceeding a boundary (ACT 103). In this example, the processor 10 determines whether or not the operation content is an “enlargement” or “movement” operation illustrated in FIGS. 6A and 6B. If the operation content is not the “enlargement” or “movement” operation (ACT 103, No), the processor 10 performs the corresponding operation as it is. Performing the corresponding operation here is to redraw a card or to update card position information or card direction information according to the operation content.

If the operation content is the “enlargement” or “movement” (ACT 103, Yes), the processor 10 determines whether or not the corresponding card exceeds the boundary due to the operation (ACT 104). If the card does not exceed the boundary (ACT 104, No), the processor 10 performs the corresponding operation as it is (ACT 108). If the card exceeds the boundary due to the operation (ACT 104, Yes), the processor 10 refers to the permission table illustrated in FIGS. 6A and 6B (ACT 105). In an operation which causes intrusion of the card into the designated region from the shared region, FIG. 6A is referred to, and in an operation which causes an outing of the card to the shared region from the designated region, FIG. 6B is referred to.

As a result of referring to the permission table, in a case of permission (ACT 106, Yes), the operation is performed as it is (ACT 108). In a case of non-permission (ACT 106, No), the processor 10 performs the operation so that the card does not exceed the boundary (ACT 107).

The operations in ACT 103 to ACT 107 and ACT 108 are repeatedly performed until the fingertip is separated from the card (ACT 109, a loop of No). In addition, the operations in ACT 101 to ACT 109 are repeatedly performed until the designated region is erased (canceled) (ACT 110, a loop of No).

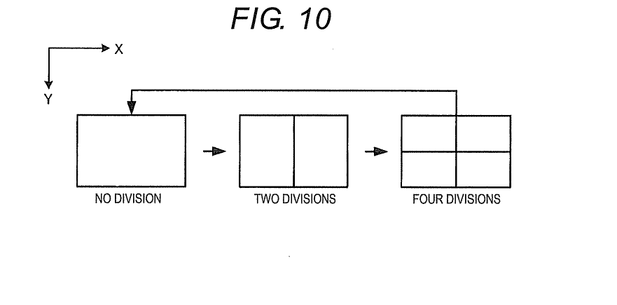

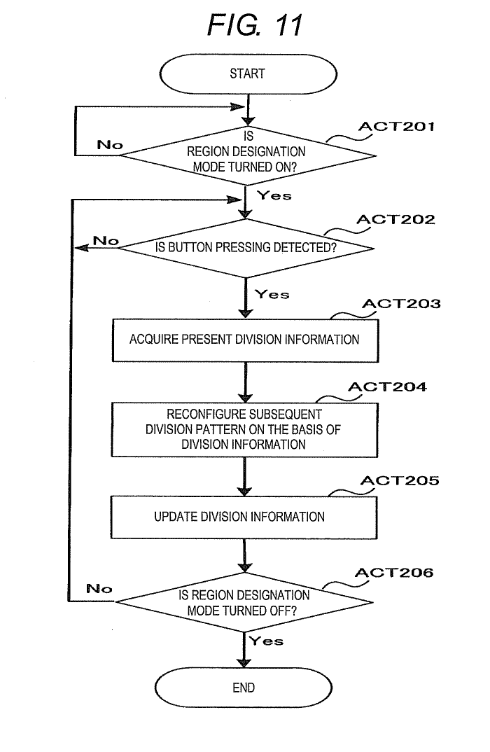

In the above description, an implementation example was described in which the touch panel display 50 is touched with the fingertip or the pen tip, and a region is designated by the movement (trajectory), but the tabletop information processing apparatus 100 may divide the touch panel display 50 into predefined regions so as to create a designated region. This implementation example will be described with reference to FIGS. 10 and 11.

FIG. 10 illustrates an example of division. In this example, a button (not illustrated) for dividing a screen region is prepared in advance, and, if the button is pressed, a display region of the touch panel display 50 is divided in a predefined pattern. If there are a plurality of patterns, the patterns are changed whenever the button is pressed. The patterns may include “no division”, so that a region can be canceled. In the embodiment, the processor 10 repeatedly performs control so as to perform 0 divisions (no division), two divisions, and four divisions.

FIG. 11 is a flowchart illustrating an operation example when the region division is performed. The processor 10 determines whether or not the region designation mode is turned on (ACT 201), and if the region designation mode is turned on (ACT 201, Yes), the processor 10 waits until a predetermined button (not illustrated) is pressed (ACT 202, a loop of No). If the predetermined button is pressed (ACT 202, Yes), the processor 10 acquires the present division information (ACT 203). The division information is a numerical value indicating which division pattern currently occurs, and is stored in the HDD 40 or the DRAM 20. In this example, it is assumed that a case of no divisions is set to 0, a case of two divisions is set to 1, and a case of four divisions is set to 2.

The processor 10 reconfigures a region division so that the present pattern becomes a subsequent division pattern (ACT 204). Specifically, if acquired division information is 0 (no division), the processor 10 performs control so that two divisions occur, and if division information is 1 (two divisions), the processor 10 performs control so that four divisions occur. If division information is 2 (four divisions), control is performed so that no division occurs. The control here indicates updating of the map data, drawing of a boundary line, changing of a region color, and the like. Next, the processor 10 updates the division information to the changed value (ACT 205). The operations in ACT 202 to ACT 205 are repeatedly performed until the region designation mode is turned off (ACT 206, a loop of No).

In addition, a positive number counter in which 1 is added whenever a predetermined button is pressed may be provided in the DRAM 20 or the HDD 40. In this case, the processor 10 calculates a remainder (0, 1, or 2) obtained by dividing a counter value by 3, and performs control so that a division pattern corresponding to the remainder value occurs.

Then, the processor 10 controls whether or not to permit a card disposed outside a single divided region to enter the single divided region on the basis of the map data or the permission table. This control follows the flowchart illustrated in FIG. 9. In addition, if a divided region is created on the basis of a predefined pattern as mentioned above, there may be a configuration in which all regions are used as designated regions, and there may be a configuration in which any one is used as a shared region, and the other regions are used as designated regions.

In the embodiment, a case was described in which functions of implementing the embodiment are recorded in the apparatus in advance, but the embodiment is not limited thereto. The same functions may be downloaded to the apparatus from a network, and the functions may be recorded on a recording medium and may be installed in the apparatus. As long as a recording medium such as a CD-ROM can store a program and can be read by the apparatus, a form of the recording medium may employ any form. In addition, as mentioned above, the functions which are installed in advance or downloaded may be realized in cooperation with an operating system (OS) of the apparatus.

In the embodiment, an aspect of the tabletop information processing apparatus was described, but an aspect is not limited thereto. For example, a tablet type computer may be employed.

A control unit corresponds to a configuration which includes at least the processor 10, the DRAM 20, and the communication bus B. In addition, the program which is operated in cooperation with each hardware element such as the processor 10, the DRAM 20, and the communication bus B is stored in the HDD 40 (or the ROM 30) in advance, and is loaded to the DRAM 20 by the processor 10 so as to be arithmetically executed. A display unit and an input unit correspond to the touch panel display 50. A storage unit corresponds to the DRAM 20 and the HDD 40. The storage unit may be located outside the information processing apparatus.

As described above in detail, according to an aspect of the embodiment, overlapping of display images can be minimized, and thus visibility and operability of each image can be prevented from being impaired.

The invention can be implemented in various forms without departing from the spirit or main features. For this reason, the above-described embodiment is only an example in all respects, and is not to be construed as being limited. The scope of the invention is represented by the claims, and is not restrained by the specification text. In addition, all modifications and various alterations, alternatives and reforms included in the equivalents of the claims fall within the scope of the invention.

What is claimed is:

1. An information processing apparatus comprising:
a display unit;
a touch panel type input unit that is disposed on the display unit and configured to receive an input from a user by detecting a contact; and
a control unit configured to create a closed region in a display region of the display unit on the basis of a trajectory obtained by the input unit detecting a contact, determines whether or not an image disposed outside the closed region displayed on the display unit is permitted to enter the closed region due to a user's operation received by the input unit, and controls display of the image on the display unit so that display corresponding to a determination result occurs.

2. The apparatus according to claim 1,
wherein the control unit determines whether or not an image disposed inside the closed region displayed on the display unit is permitted to come outside of the closed region due to a user's operation received by the input unit, and controls display of the image on the display unit so that display corresponding to a determination result occurs.

3. The apparatus according to claim 1, further comprising:
a storage unit that stores information indicating permission or non-permission for each operation content item,
wherein the control unit acquires the information corresponding to a user's operation received by the input unit from the storage unit, and performs the determination on the basis of the information.

4. The apparatus according to claim 2, further comprising:
a storage unit that stores information indicating permission or non-permission for each operation content item,
wherein the control unit acquires the information corresponding to a user's operation received by the input unit from the storage unit, and performs the determination on the basis of the information.

5. The apparatus according to any one of claims 1,
wherein the control unit creates the closed region so that an area outside the closed region is not lower than a prescribed value.

6. The apparatus according to any one of claims 2,
wherein the control unit creates the closed region so that an area outside the closed region is not lower than a prescribed value.

7. The apparatus according to any one of claims 3,
wherein the control unit creates the closed region so that an area outside the closed region is not lower than a prescribed value.

8. An information processing apparatus comprising:
a display unit;
a touch panel type input unit that is disposed on the display unit and receives an input from a user by detecting a contact; and
a control unit that performs control so that a display region of the display unit is divided in a predefined form if the input unit receives a predefined operation, determines whether or not an image disposed outside a single divided region enters the single divided region due to a user's operation received by the input unit, and controls display of the image on the display unit so that display corresponding to a determination result occurs.

9. A computer-readable storage medium storing a program for causing a computer to execute controlling a display, wherein the computer includes a display unit and a touch panel type input unit that is disposed on the display unit and receives an input from a user by detecting a contact, comprising:
creating a closed region in a display region of the display unit on the basis of a trajectory obtained by the input unit detecting a contact;
determining whether or not an image disposed outside the closed region displayed on the display unit is permitted to enter the closed region due to a user's operation received by the input unit; and
controlling display of the image on the display unit so that display corresponding to a determination result occurs.
